(19) United States
(12) Patent Application Publication
(10) Pub. No.: US 2010/0312649 A1
(43) Pub. Date: Dec. 9, 2010

(54) METHOD AND APPARATUS FOR MARKETING OVER AN ON-LINE NETWORK

(75) Inventor: Zander LURIE, County of New Castle, DE (US)

Correspondence Address: Reed Smith LLP, P.O. Box 488, Pittsburgh, PA, 15230, US

(73) Assignee: CBS Interactive, Inc., County of New Castle, DE (US)

(21) Appl. No.: 12/792,976

(22) Filed: Jun. 3, 2010

Related U.S. Application Data
(60) Provisional application No. 61/183,810, filed on Jun. 3, 2009.
(60) Provisional application No. 61/226,570, filed on Jul. 17, 2009.

(51) Int. Cl. G06Q 30/00

(52) U.S. Cl. 705/14.66; 705/1.1

(57) ABSTRACT

A computer system and computer implemented method for presenting marketing messages to users of a computer network whereby relevant message will be presented to users based on a profile derived from social network information and financial information, the method comprising. The user is registered through a web site or the like. A marketing profile of the user with respect to a specific marketer is determined based on a social graph of the user and a commerce graph of the user. Marketing messages to be distributed to the user are selected based on the marketing profile of the user and the messages are presented to the user.

### CLAIM OF PRIORITY

The present application claims the benefit of priority of U.S. Provisional Patent Application Ser. No. 61/183,810 filed on Jun. 3, 2009 and U.S. Provisional Patent Application Ser. No. 61/226,570 filed on Jul. 17, 2009, the entire contents of which are incorporated herein by reference.

### BACKGROUND

1. Field of the Invention

The invention relates to marketing branded offers over an on-line network.

2. Description of the Related Art

Online “social networks”, and other collaborative sites have become very popular because of their ability to allow users to share their interests, activities and thoughts with other users. Many people use social networks to keep in touch with friends and locate friends with whom they have not kept in touch previously. Accordingly, social networks have become a very powerful tool for establishing and documenting interactions between people of mutual interests. Examples of such social networks include MySpace™, Facebook™, LinkedIn™, and Epinions™. Further, many commercial sites, such as Amazon.com™, have integrated a social networking aspect into their primary products. For example, Amazon.com™ includes “friends and recommendations” which permits users to view products recommended by people they know.

Social Network sites like Facebook provide a venue and source for “word of mouth” (WOM) activity. WOM marketing is $3 billion market growing over 20% annually. WOM is based on the assumption that consumers place value in recommendations from people they know or with whom they share common interests. There have been several attempts at leveraging social networks and other Web sites for the purpose of WOM advertising. For example, vyrl mkt, Inc.™ sells the Vyrl Multiplier™ system directed to position brands effectively into social networks. Vyrl Multiplier™ is a targeting system that utilizes user profiles to direct advertising in social networks based on previous user activity within the social network.

In contrast, Loyalty and Discount Marketing (“loyalty programs”) constitute a $10 billion market. Consumer always want discounts and coupons. Accordingly, there have been attempts to leverage the power of social networks for loyalty programs. For example, US Published Patent Application No. 2007/0121843 discloses a system in which offers, such as product discounts are made to potentially influential users. The potentially influential users are identified based on user criteria obtained from the social network map of the user and previous user on line activity. Once identified, influential users are encouraged to provide reviews of products that they have tried in an attempt to reach other users. Branded messages are placed on a web page associated with individual influential users and the influential users are rewarded based on the number of other users that take advantage of product offers through the branded messages on their web page.

### BRIEF DESCRIPTION OF THE DRAWING

FIG. 1 is a schematic illustration of a data structure for storing social graph information.

FIG. 2 is a flow chart of a methodology for determining a market score.

FIG. 3 is a flow chart of a method in accordance with an embodiment.

FIG. 4 is a schematic illustration of relationships between users of a social network.

FIG. 5 is a schematic block diagram of a computer system used to implement the embodiments.

FIG. 6 is a schematic illustration of a process for creating a marketing profile.

FIG. 7 is a schematic illustration of a process for merchant registration.

FIG. 8. is a schematic illustration of a process for creating a targeted marketing strategy.

FIG. 9 is a schematic illustration of a process for monitoring user acceptance of offers.

FIGS. 10-16 illustrate a use scenario of an embodiment.

FIG. 17 is a schematic illustration of delivery mechanisms for offers.

### DETAILED DESCRIPTION

A large amount of content and services offered on the Internet is funded by an advertising model. However, advertising may be regarded by some consumers as annoying and distracting. Further, consumers often feel that targeted advertising campaigns, where ads are directed to consumers based on the consumer's activities, are obtrusive. As a result, on-line advertising has stagnated over recent years after seeing large growth between 2003 and 2007.

Applicants have developed a system and method for leveraging social networks and other user activities to derive a social graph that can be used for marketing. The social graph combined with other user related information is mapped to the user's commerce graph to provide consumers with relevant messaging and marketers with a highly targeted mechanism for identifying and reaching the most valuable customers and prospects. In the disclosed embodiments, marketers can identify key members of a social network based on the social network map information and commercial information associated with the key users. A marketing profile for individual users can be determined based on the social graph, other user related information such as behavioral or demographic information and the commerce graph to allow marketers to fashion a marketing program that is efficient and effective. The term “marketer” as used herein can be any party wishing to provide targeted messaging, such as advertisements, coupons, offers, and other commercial messages. A marketer can be a specific on line or bricks and mortar store or a collection of such stores, other entities or a brand.

The commerce graph can include any financial information related to the consumer, such as commercial transaction information or other records of transactions with a specific marketer, or plural marketers, or asset and debit information. The social graph can include any information gleaned from relationships of an on-line social network, or other collaborative environment, such as a number of connections to others, the identity and interests of connected parties, the centrality of a user in the social network map, social distances, and the like. The commercial transaction information associated with others in a user's social graph can also be derived. The manner in which marketers can leverage the system and specifics of a preferred embodiment are described in greater detail below.

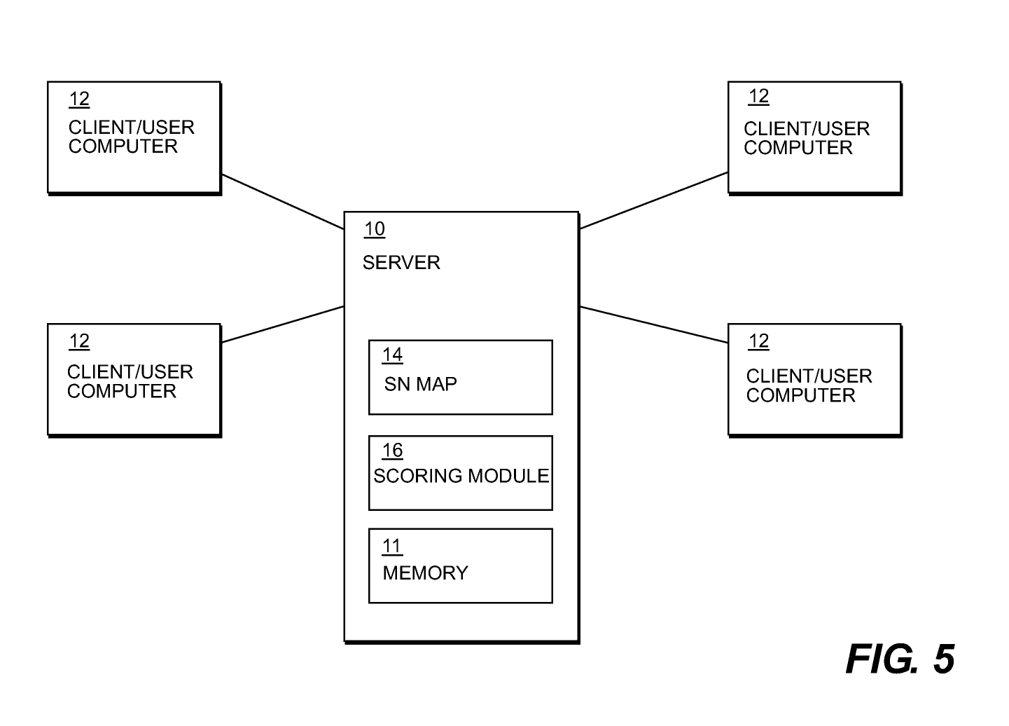

As illustrated in FIG. 5, the invention is implemented on a computer network environment, such as the World Wide Web of the Internet. Server 10 is a computer device, or plural computer devices, executing a software program for implementing the functions described below. The software program is recorded on computer readable media, such as memory 11, in the form of computer executable instructions. When executed by a processor of server 10, the instructions carry out the various described functions. Users, consumers and marketers in this scenario, can access the functions of server 10, and other computer devices through client computers 12. Client computers 12 can run a browser or other client side software to access server 10. While the connections between server 10 and client computers 12 are shown schematically in FIG. 5 as direct lines, the computers can be connected directly or indirectly through any known connection, such as the Internet, a LAN, a WAN, or other connections.

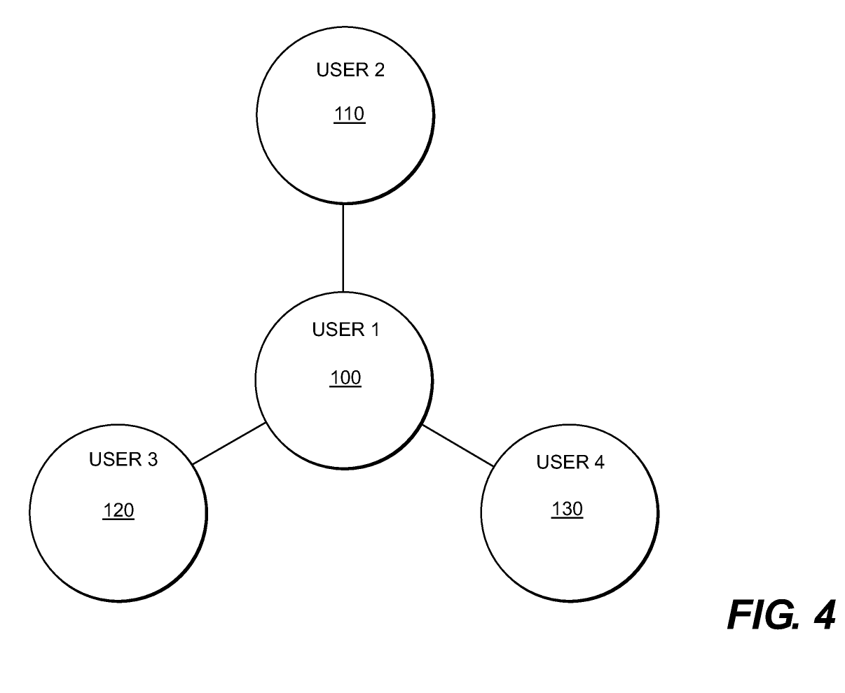

FIG. 4 schematically illustrates the relationships of users of a social network in the form of a map. The map consists of nodes 100, 200, 300, and 400 and connections between the nodes. Each node represents a user. In the example of FIG. 4, the user of node 100 has a direct connection with the users of nodes 110, 120, and 130. The nodes and connections are stored as map 14 in social network server 10 of FIG. 5. Of course, nodes 110, 120, and 130 can be connected to other nodes and to each other to make a complex map of direct and indirect connections between nodes, and thus users of the social network. As an example, a direct connection can be called a “friend” while an indirect connection can be called a “friend of a friend”. The number and/or complexity of connections between nodes is referred to as a “social distance”.

Each user of the social network has an account and can display a series of personalized pages on client computers 12 when accessing the social network, as is well known. The invention leverages the relationships of the users of a social network, and other collaborative Web sites, and the commercial influence of a user against specific products, merchants, and brands to present commercial messages to the user in a targeted manner and to reward the user for response to the commercial messages and other commercial activity with a marketer. The inventors have developed a system for marketing that fully leverages the inherent power of a social network by rewarding key users and incenting the key users to promote brands by word of mouth.

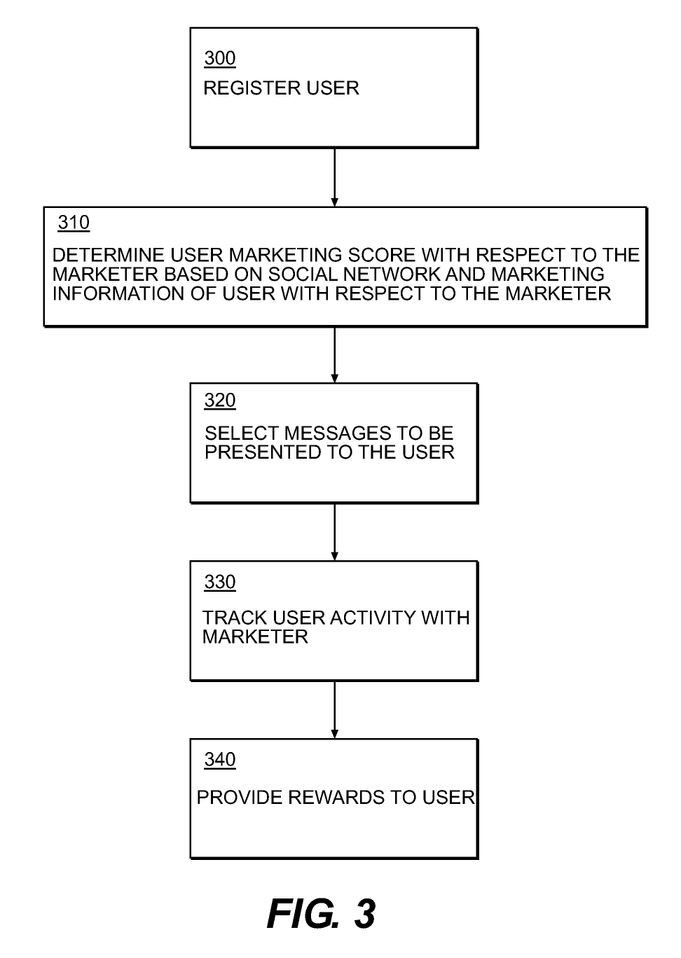

FIG. 3 illustrates the steps in accordance with an embodiment of a method. The steps of FIG. 3 are accomplished by communication between client computers 12, and social network server 10. In step 300, a user of the social network is registered, by a registration module. Registration can include the collection of user information in a known manner. When a user registers, the user is assigned a unique identifier, for example a number or alphanumeric code. Also, an account is established for the user. The account can be a new or existing credit account, debit account, or some other financial account that can be used in transactions with a marketer in connection with the purchase of goods or service. A physical token can be assigned to the user in connection with the account. For example, the token can be a conventional debit card, credit card, or smart card. Also, various indentifying tokens can be used as is well known. The identifier can be used to indentify the user's commercial activities and rewards as described below. The registration of step 300 can be accomplished through game play. For example, when a user displays a web site in a browser window, the user can be offered an online game to play. At certain points of the game, users who are not logged in to the web site, can be asked to register to continue the game. Users can be rewarded for reaching levels or specified scores in the game.

In step 310, a marketing profile, in the form of a marketing score in this example, is determined for the user. As noted above, the marketing score for the user can be determined based on social graph and a commerce graph of a consumer. Specifically financial information is laid over social network map information to provide a score indicative of the value of the user to a specific marketer. In the preferred embodiment, the commerce graph of the consumer is financial information related to spending of the consumer with a specific marketer or a variety of marketers and other financial information. Step 310 can be accomplished before or after registration. For example, a marketing score can be calculated to determine if a user should be permitted to register. If the marketing score is of a certain value or range, the consumer can be permitted to register. The information for calculating the marketing score can be gathered before or after registration and can be updated based on user activity as discussed below. Also, the marketing profile can take various forms other than a score. For example, the marketing profile can be a list, a chart, a database, or other mechanism for indicating marketing information for the user.

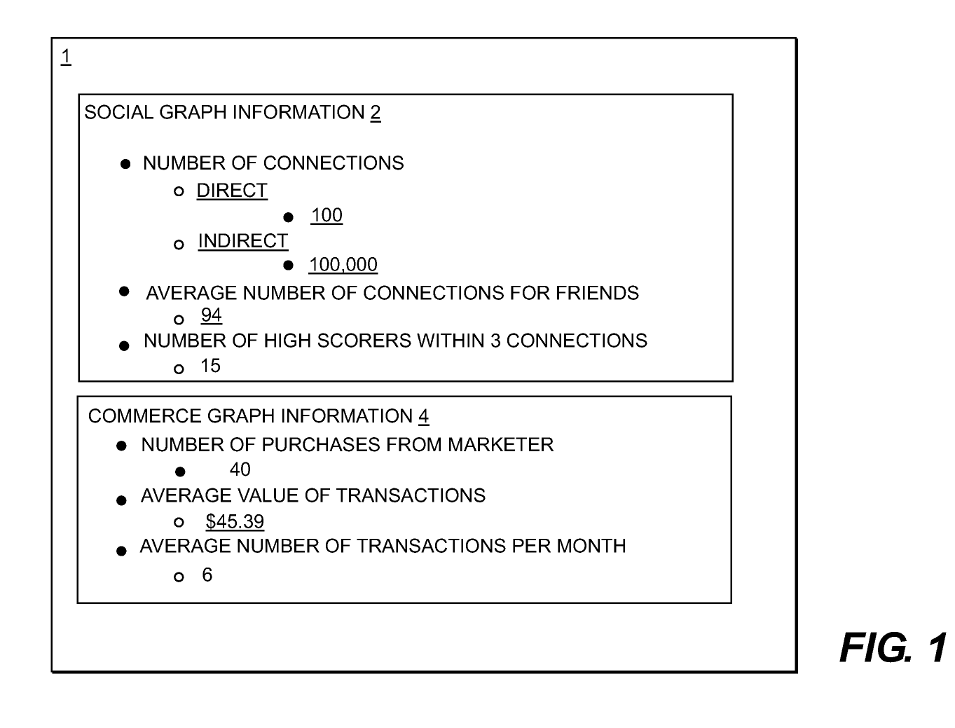

FIG. 1 is an example of a data structure for storing social graph information and commerce graph information of a user. Data structure 1 of the embodiment includes social graph information 2 of a user and commerce graph information 4 of the same user. Social graph information 2 includes the number of direct and indirect connections of the user in the social network, the average number of connections for each “friend” of the user, and other relevant information. Note that social graph information 2 of the embodiment also includes the number of high scorers that are within three connection hops of the user in the social network. High scorers can be other users who scored a certain value or range of values in the marketing score. This number is indicative of how many other influential users are in this user's social map. Of course, any other social network information that is relevant to the user's marketing value can be stored in the data structure and/or used to determine a marketing score. Commerce graph information 4 includes the number of purchases by the user from the marketer(s), the average value of the purchase transactions, and the monthly average number of transactions. Of course, commerce graph information could include other financial information of the user, such as information relating to the user's assets and/or liabilities. An example of calculation of the marketing score is provided below.

Returning to FIG. 3, in step 320, a marketer determines messages to be sent to the Consumer. One possibility is that the marketing score for that Consumer is too low to send messages at all. However, marketers will want to reach out to relatively high scoring consumers, i.e. consumers who have a purchase history with the marketer and/or influence within the social network. The messages can be advertisement, discount offers, coupons, invitations or any other commercial message. The methodology for determining how to target consumers with messages is discussed below.

In step 330, consumer activity with the marketer, such as user purchase transactions, or visits to a web site or bricks and mortar store, are tracked. In step 340 rewards are provided to the user based on the activity. For example, for a specified number or dollar amount of transactions, the user can be rewarded with a credit to their account, a special offer, cash, or any other reward in a known manner. The tracking of user activity and rewarding for the same is described in more detail below.

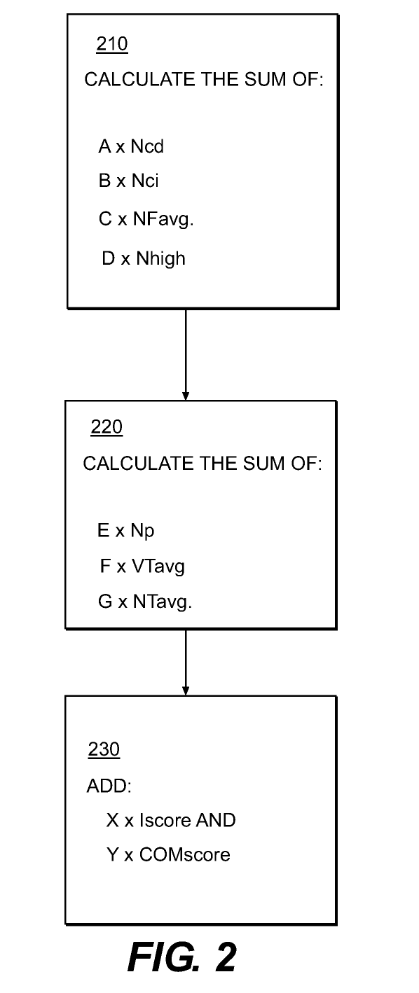

FIG. 2 illustrates a methodology that can be used to determine the marketing score of a user with respect to a specific marketer or a collection of marketers. The methodology of FIG. 2 is performed on the data in the data structure of FIG. 1 by scoring module 16 (FIG. 5). Note that scoring module 16, or any other portion of the embodiment can be provided by a third-party as a service. The variables referenced in FIG. 2 are defined as follows:
Ncd=the number of direct connections for the user in the social network;
Nci=the number of indirect connections for the user in the social network;
NFavg=the average number of connections to friends of the use in the social network;
Nhigh=the number of high scorers within 3 connections of the user in the social network;
Np=the total number of purchases by the user form the relevant marketer;
VTavg=the average value of transactions between the user and the relevant marketer;
NTavg.=the average number of transactions between the user and the relevant marketer per month;
Iscore=The total influencer score of the user;
COMscore=the total commercial score of the user with respect to the vendor;
Marketing Score=Iscore+COMscore; and
A, B, C, D, E, F, G, X, and Y are weighting factors.

In step 210, the data from social graph information 2 is weighted by multiplying each value by the indicated weighting factor. The weighted values are then added together to provide Iscore, the total influencer score for the consumer. In step 220, the data from commerce graph information 4 is weighted by multiplying each value by the indicated weighting factor. The weighted values are then added together to provide COMscore, the total commercial score for the user with respect to the relevant marketer. In step 230, the total influencer score and the total commercial score are weighted and then added together to yield a marketing profile, in the form of a marketing score, for the user with respect to the marketer.

Note that the market score has a component that is based on the user's influence (i.e. social network status) the user's transaction history with the relevant marketer or collection of marketers, and other financial information such as assets, liabilities, and the commercial transaction history of others in a user's social graph. This provides a metric of the user's influence over the brand or brands of interest to the marketer. Note the marketing score can be determined for a single user or multiple users and for a single marketer and for multiple marketers. It might be desirable for a single marketer to determine the marketing score for many users with respect to the marketer to design an efficient and effective marketing campaign. Of course, the marketing score can be continuously or periodically recalculated based on changes in the user's social network map and/or financial activity.

Marketers can design marketing campaigns based on marketing scores for various users, alone or in combination. Marketers can select the weighting factors of FIG. 2 based on specific priorities for the campaign. A service provider can create sets of predetermined weighting factors for specific types of users, such as “well connected, high transaction price purchasers” or “deeply connected regular transaction purchasers”. In this manner, the service provider can offer predefined marketing campaigns for potential marketers desiring a specific demographic. The embodiment also allows marketers to manage messaging in flexible ways. For example, marketers can bid what they want (i.e. higher discounts yield higher penetration; and vice-versa). A marketer has the ability register an initial message, e.g. an offer, that would be that would be sent to a user and secondary offers that will be sent to the user after acceptance of the initial offer. Secondary offers may be based on a user's level of consumption of the marketers product or service or the level of influence a user has. Essentially, a marketer has the ability to develop an incentive campaign based on an initial incentive offer made to all first time users who qualify to be identified with their brand and then a series of incentive offers that may be made to users that have identified with their brand based on the rules a marketer may develop based on a users consumption or influence associated with the brand. A marketer may submit information related to desired consumers and the consumer profiles of various consumers can be matched to the marketer information to provide a pool of consumers most likely to respond favorably to the marketer's messaging. In the example discussed above, the profile is a single score. However, the various component scores can be part of the profile to allow marketers to adjust and direct campaigns with greater resolution. Also, as noted above the profile can be information other than scores.

Marketers can be given access to data and the ability to market to users through direct mail/email, RSS, social networks, or other communication platforms. The embodiment provides marketers with a dynamic vehicle to move perishable inventory (e.g. deals on hotel rooms, airlines, excess inventory, etc.) or other inventory that is most desirable to sell. Marketers can experiment with various offers and discounts to maximize return on their offers. The embodiment captures transactional information in conjunction with social networks' data to provide marketers with comprehensive and effective data. Marketers can pay a fee on all transactions generated through the embodiment or marketers can pay a subscription fee to participate. The embodiment can be used with various business models.

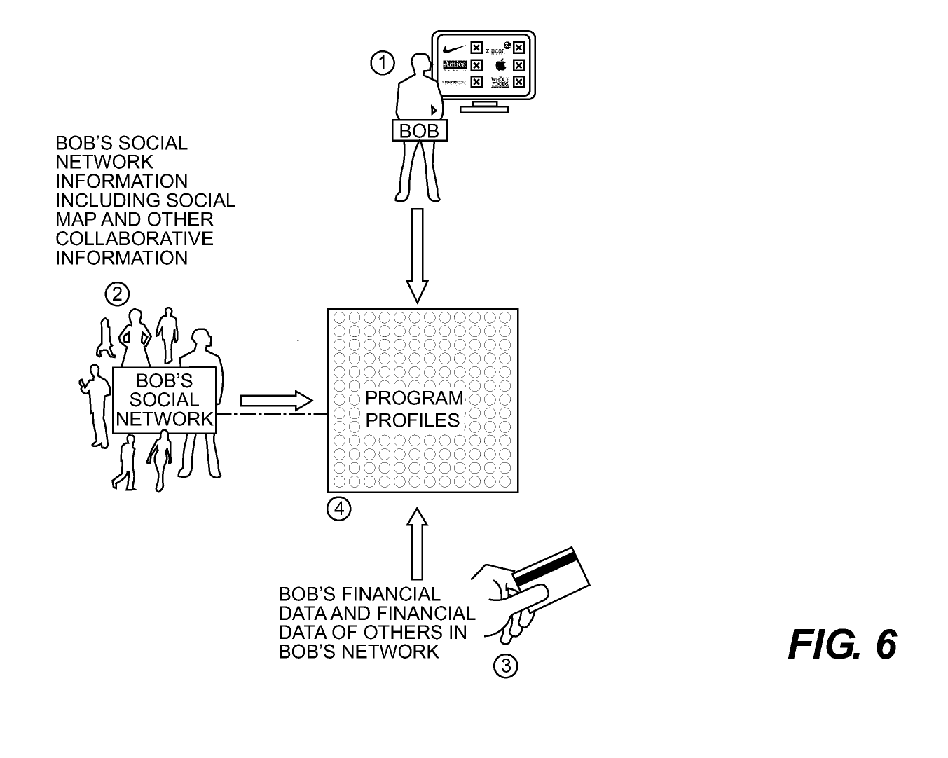

FIG. 6 illustrates an overview of the marketing profile creation process in accordance with the embodiment. A consumer registers for the marketing program (step 300 of FIG. 3). The marketing profile is based on the consumer's brand preferences, social capital, and behavior as described above. Upon registration, a consumer can be asked to provide brand information related to favorite brands, stores, and the like. The consumer grants access to their social networks and social network information (social graph) for the consumer is retrieved. Also, since relationship data is obtained, data about the commercial behavior of the consumer's friends can be obtained. Of course, the friends may have to register and grant permission for access to their data in a similar manner. Further, the user grants access to transaction information (commerce graph). The marketing profile is determined in various manners based on this information, such as in the manner described above. These functions can be carried out through client computers 12 and server 10 of FIG. 5. Marketing profiles can be stored in memory 11 of server 10.

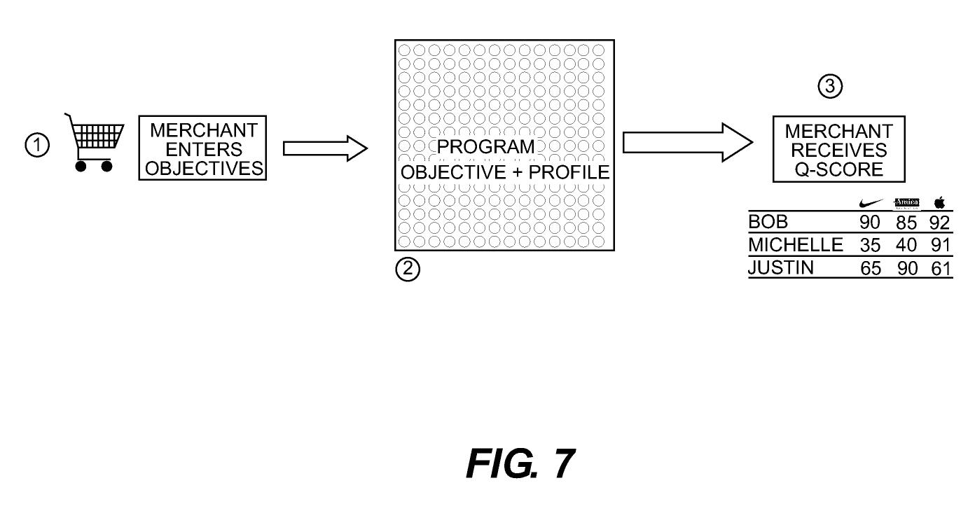

FIG. 7 illustrates an overview of a merchant registration process. Merchants register and provide marketing attributes indicating marketing objectives or other criteria. The marketing attributes can be provided in any form, such as through answers to questions of checking boxes on a predetermined form. Server 10 receives marketing objective data. The marketing objectives are compared to consumer marketing profiles stored in memory 11 (FIG. 5) and a list of valuable consumers can be determined by server 11. The size of the list can be adjusted to marketing preferences and budgets by filtering and adjusting weighting factors.

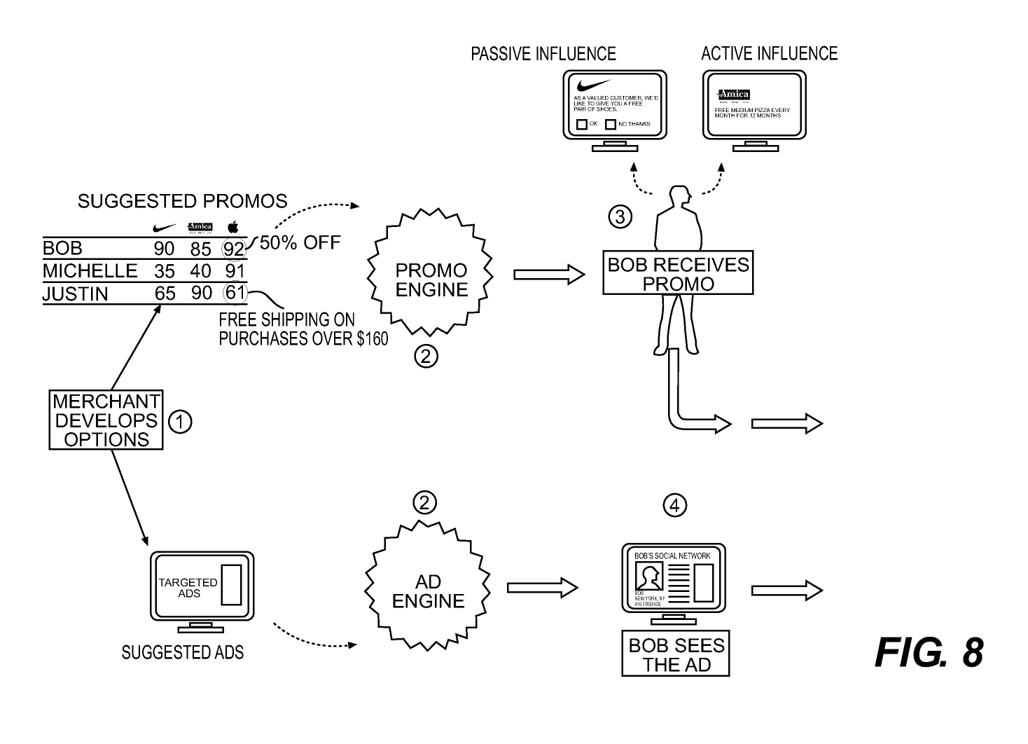

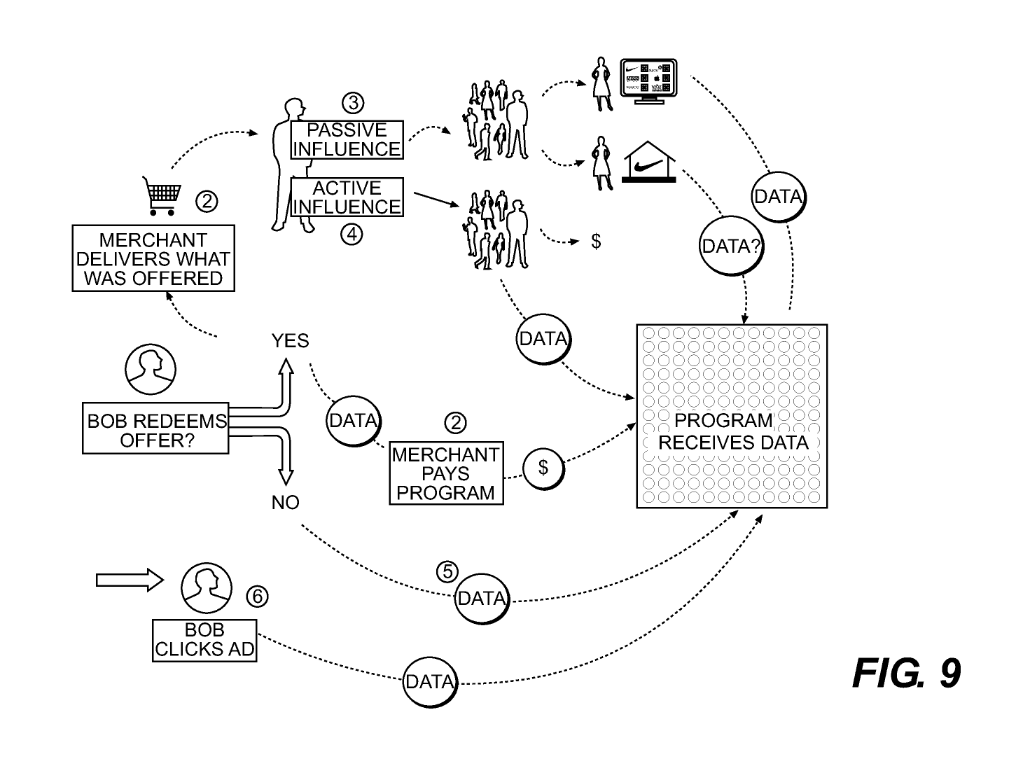

FIG. 8 illustrates an overview of a process for creating a targeted marketing strategy. A merchant can create specific messages, such as ads, discount offers or the like. The messages are then distributed to consumers on the list of matching profiles. Distribution can be accomplished in various ways. Messages are tied to the user ID and/or token. For example, the user need not even be aware that the message was distributed. The user can become aware of the message at the point of sale, for example, where a discount is applied to a purchase upon presenting the ID or token. Messages can also be distributed by email, on a web site, through a social network, or the like. Some messages encourage “passive influence”, such as free or discounted goods or services for a valued consumer. Other messages encourage “active influence”, such as free or discounted goods or services in exchange for the consumer partaking in a specific commercial activity other than the transaction (See FIG. 9).

FIG. 9 illustrates an overview of a monitoring process. Consumers can accept/use or reject/not use the offers conveyed in messages. This information can be tracked by server 11. If the user accepts and redeems and offer conveyed in a message, the Merchant provides the goods or services in the offer. Any remuneration to the consumer can be provided at the point of sale or can be credited to a consumer account. Such as the account tied to the token as described above. All activity is tied to the ID or token and thus is tracked by server 11 to measure effectiveness.

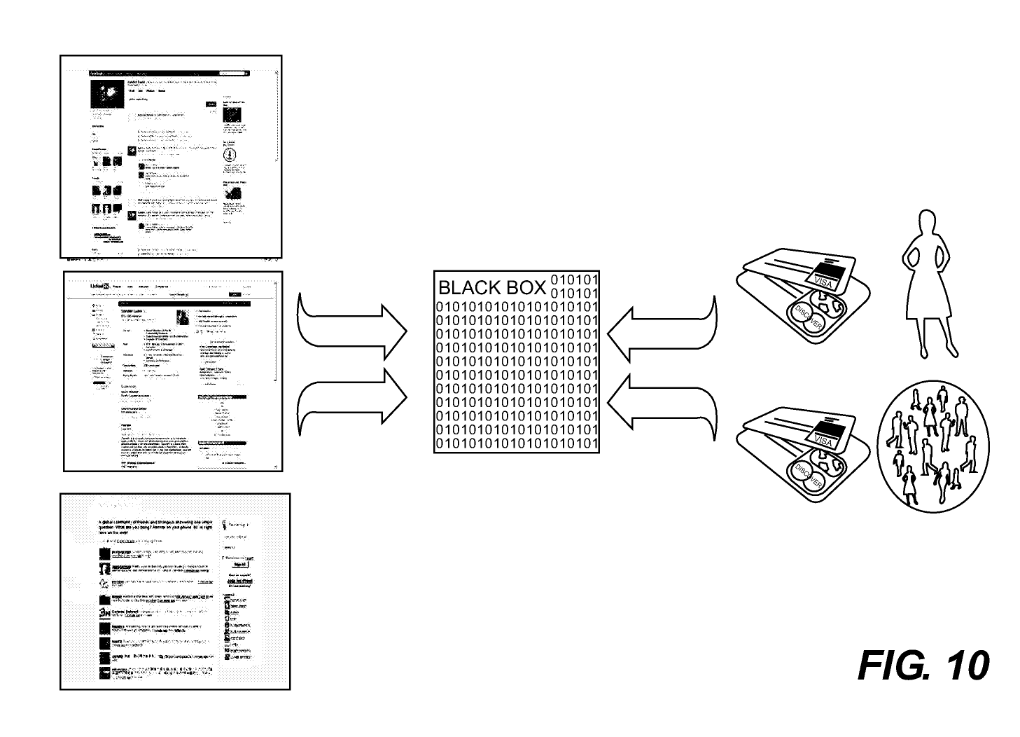

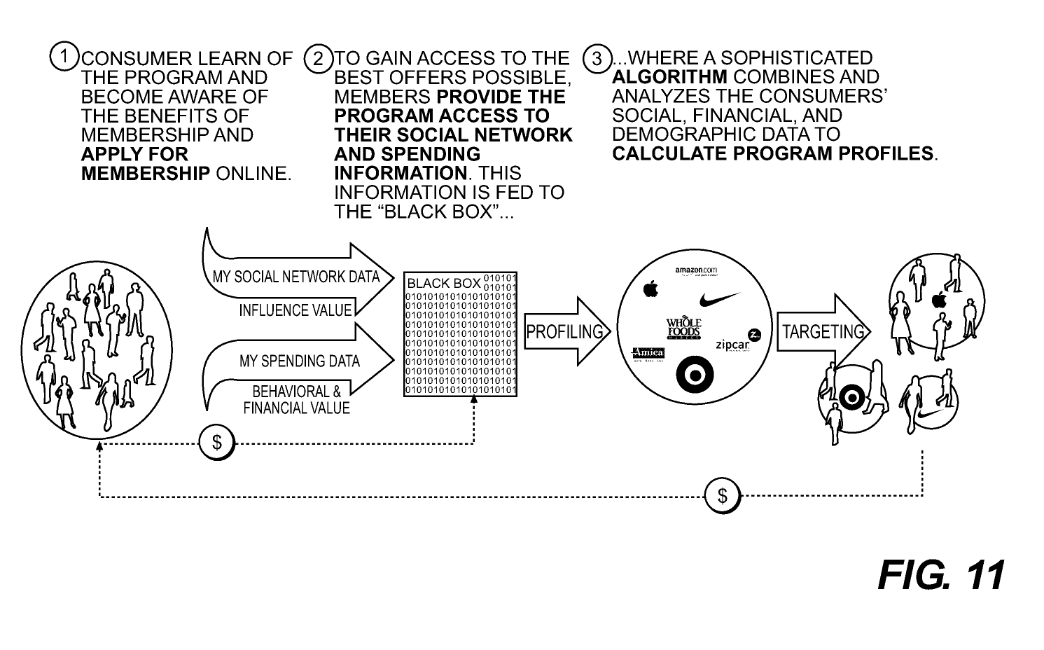

FIGS. 10-16 illustrate a use scenario of the embodiment. As illustrated in FIG. 10, a consumer social graph, including a social network map and other collaborative information about the user, is collected. Also, the consumer's commerce graph is collected. Note that the commerce graph can include all of the information noted above for the consumer with respect to one or more marketers. The information is processed to create the marketing profile for the user. More specifically, as illustrated in FIG. 11, a consumer applies for participation in the rewards program by filling out an online form or other registration form. The form provides the consumer opportunity to allow access to the consumer's information and to provide information assisting such access, such as requisite URLs and account numbers.

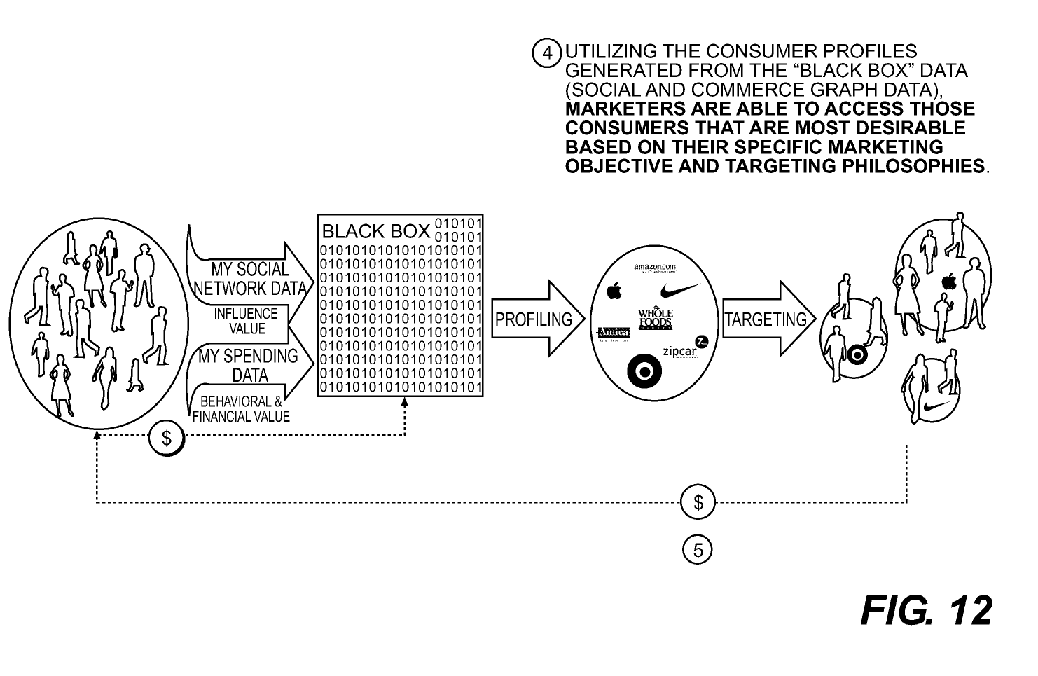

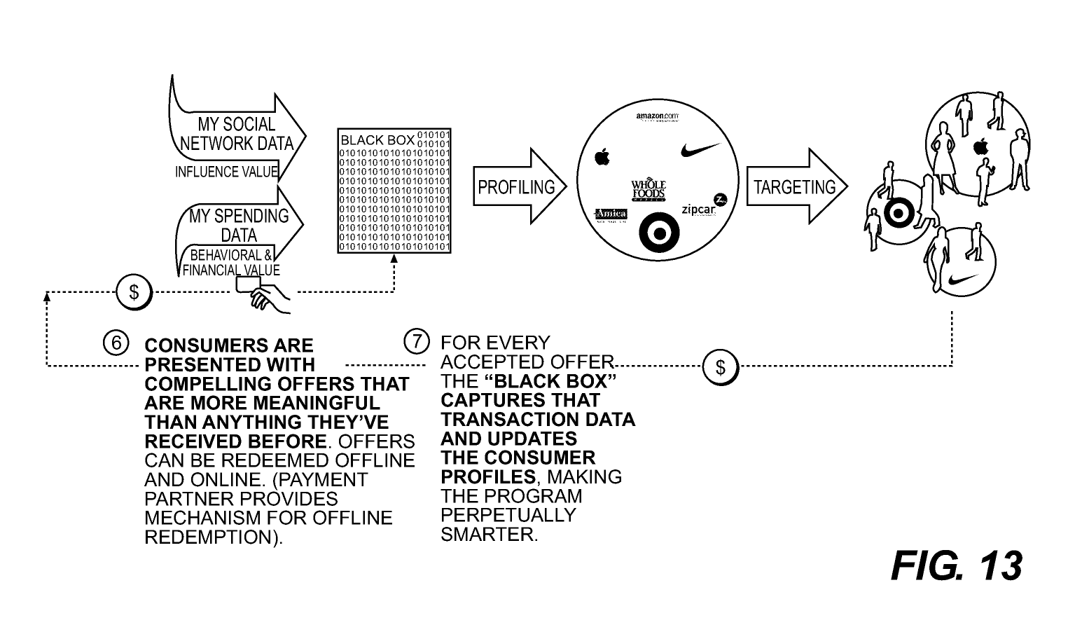

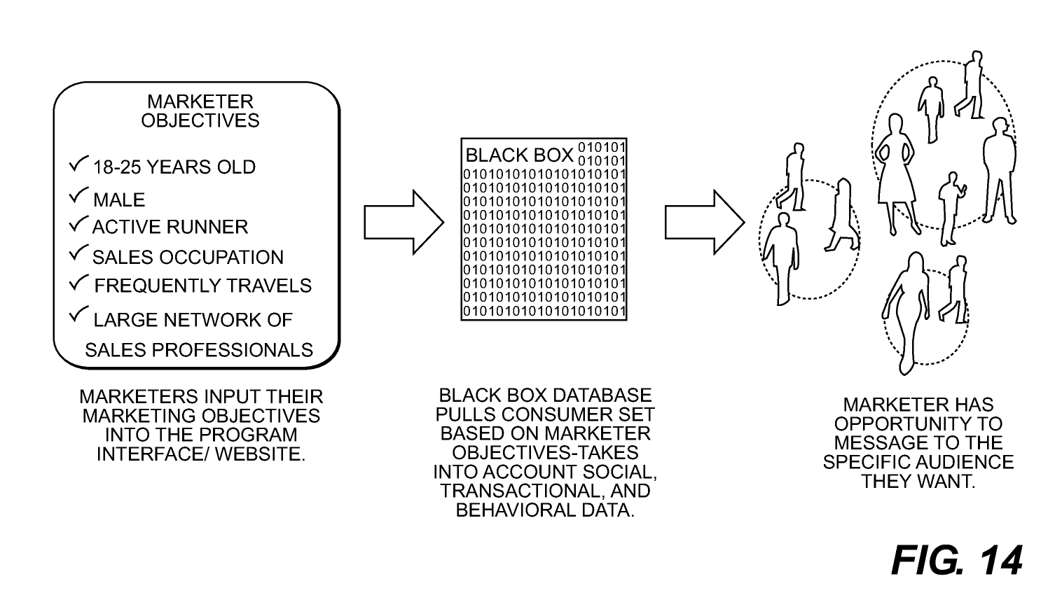

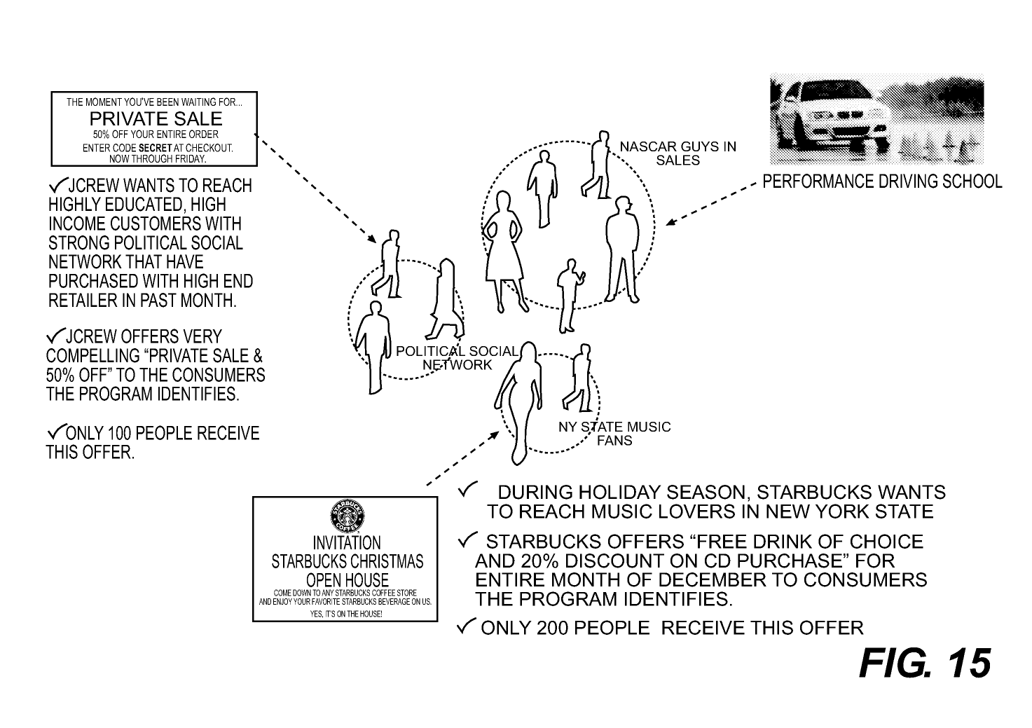

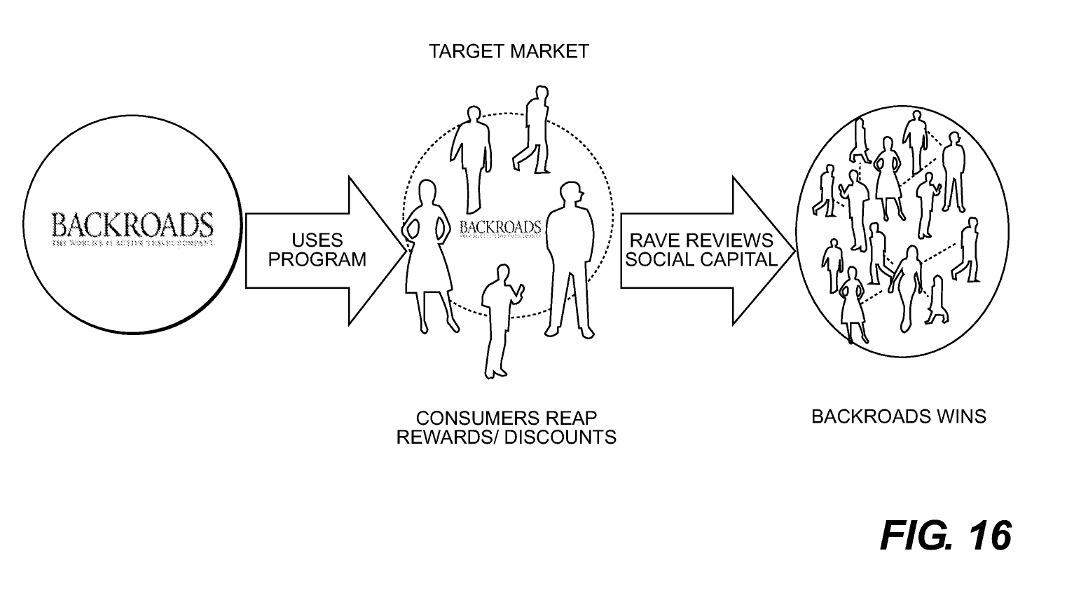

The resulting marketing profiles of multiple consumers permits a marketer to provide objectives and identify the consumers that are the most valuable to the marketer, as illustrated in FIG. 12. The identified consumers can then be targeted with marketing messages, such as compelling offers. Redemption of the offers is tracked in connection with the consumer's token and used to update the marketing profile, as illustrated in FIG. 13. FIG. 14 illustrates more detail of the consumer identification process. Desired demographics are provided by the marketer as objectives to identify the most valuable consumers. FIG. 15 illustrates a specific example of three different marketers and their objectives used to indentify consumers that are most relevant to that specific marketer. FIG. 16 illustrates the word of mouth effect that the embodiment provides for a marketer. Because the most valuable and relevant consumers can be targeted, the consumers are most likely to receive offers that they use and enjoy. The consumers in turn are more likely to spread favorable comments about the marketer to their friends and other people within their social network.

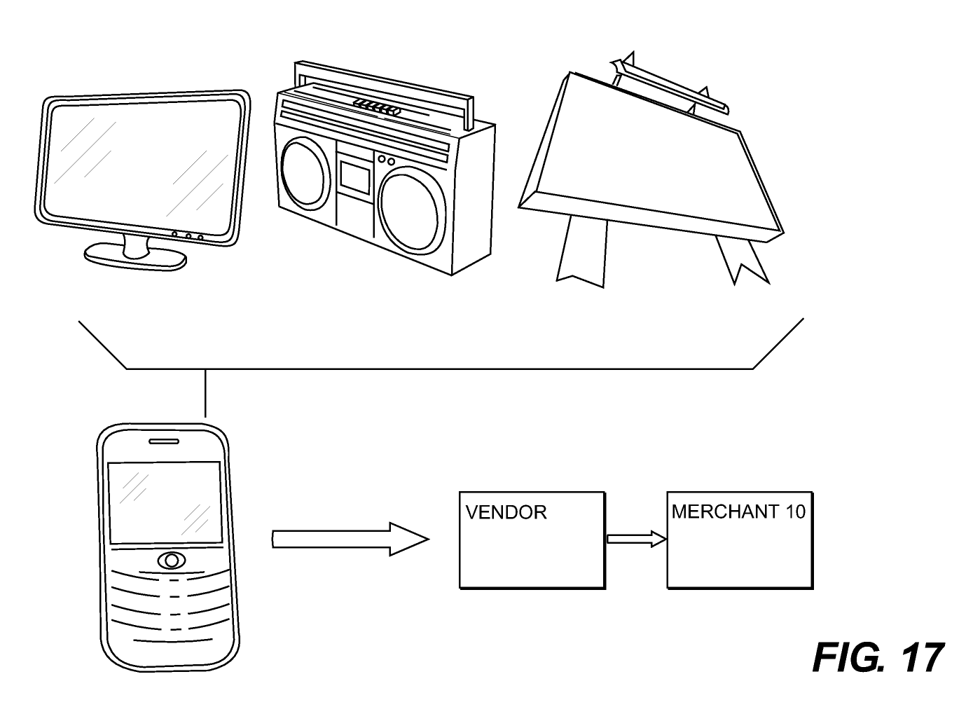

FIG. 17 illustrates another mechanism by which users can be provided offers. Mass media, such as television, radio, or billboards, can be used to deliver messages to a user. For example, a video or audio message connected with an offer can be rendered to the user. The user can then take the offer to a vendor. The offer can be identified by a word or phrase that the user records and presents to the vendor. Alternatively, the offer can be identified by an image, still or video, or sound clip that the user records on a portable device, such as a mobile phone. The recorded data can then be transformed into a predetermined code by an application running on the mobile device or by a service, such as a web service. The code can be a bar code displayed on the portable device or any other indicia of the offer. The code is then presented to the vendor to redeem the offer. Redemption data can be sent from the vendor to server 10 for use in targeting offers and creating marketing campaigns in the manner described above. Note that this mechanism does not require any active registration by the user. However, data can be supplemented by an active registration process as described above. Targeting of offers to users can be accomplished through known techniques, such as contextual targeting and user profile targeting. Offers can be sourced through various channels that are localized and non-localized. For example, national offers can be sourced through a network of web sites and local offers can be sourced through localized media outlets, such as radio or television properties.

Alternatively, the mass media broadcast can direct the user to a web site, phone service, mail in service, or other mechanism for obtaining the code/offer. Offers can be varied by media type and time to allow tracking of where and when the user viewed the message. Also, the use of mass media permits business models that include purchase of mass media advertising by marketers. For example, mass media advertisers can pay a premium to be a part of the awards program, above and beyond conventional advertising. Also, this mechanism allows viewing of mass media advertising to be tracked and used in targeting through the collection of redemption data in combination with varied offers over time and by media type.

Various information can be used to supplement the social graph and the commerce graph. For example, user provided demographic information and preference, GPS based location information, and the like can be used. Any media can be used to deliver messages.

The invention can be applied to distribution of messages to mobile devices, such as mobile phones and other mobile computing devices, as the client devices. Commercial messages, such as offers, can be directed to the mobile device of a user based on the marketing score of the user and the user's location. For example, when a user is near a marketer (as indicated by GPS or other location indication signals), messages relating the to marketer, such as discount coupons, can be sent to the user's mobile device. Further, the client device can be a television or other device displaying scheduled or on-demand programming. Commercial messages can be directed to the client device based on the marketing score of the user and the content of the programming. For example, when a particular product is placed in the programming, the user may get a coupon for that product.

The computers described above, can be any type of computing device having processor for executing computer code, such as but not limited to, the mobile phones and televisions noted above. Each computer can be a single device or multiple computing devices, such as a series of networked computers. For example, server 10 can be a single computer server or multiple devices. The function of the embodiments can be integrated into servers administering the social network or can be offered as an add on service executed on separate devices. The invention has been described through modules that consist of executable software code recorded on computer readable media. The modules are segregated and labeled by function but need not represent separate portions of code with respect to one another.

What is claimed:

1. A method for presenting marketing messages to users of a computer network whereby relevant message will be presented to users based on a profile derived from social network information and financial information, the method comprising:
registering a user;
determining a marketing profile of a specific user with respect to a specific marketer based on a social graph of the user and a commerce graph of the user;
selecting marketing messages to be distributed to the user based on the marketing profile of the user;
enabling the presentation of at least one of the marketing messages to the user;
tracking data related to use of the at least one marketing message by the user;
recording the tracked data in a database in association with the account of the user;
rewarding the user, through the account, in accordance with the tracked data.

2. The method of claim 1, wherein the at least one marketing message includes an advertisement.

3. The method of claim 1, wherein the at least one marketing message includes a discount coupon.

4. The method of claim 1, wherein said rewarding step comprises applying a credit to the account.

5. The method of claim 1, wherein said marketing profile is in the form of a marketing score.

6. The method of claim 1, further comprising receiving marketing attributes and determining a set of users that are of most value with respect to the marketing attributes based on the marketing profile.

7. The method of claim 1, further comprising notifying a user that they have a marketing message.

8. The method of claim 1, further comprising screening a user for value by conducting said determining step in advance of other steps and determining whether to conduct the other steps based on the determining step.

9. The method of claim 1, wherein said registering step comprises engaging the user in an on-line game and receiving user information at least one of during or after play of the game.

10. The method of claim 1, wherein said enabling step comprises presentation of at least one of the marketing messages through a local distribution channel and presentation of at least one of the marketing messages through a non-localized distribution channel.

11. A computer system for presenting marketing messages to users of a computer network whereby relevant message will be presented to users based on a profile derived from social network information and financial information, the method comprising:
a computing device programmed to register a user;
a computing device programmed to determine a marketing profile of a specific user with respect to a specific marketer based on a social graph of the user and a commerce graph of the user;
a computing device programmed to select marketing messages to be distributed to the user based on the marketing profile of the user;
a computing device programmed to enable presentation of at least one of the marketing messages to the user;
a computing device programmed to track data related to use of the at least one marketing message by the user;
a computing device programmed to record the tracked data in a database in association with the account of the user;
a computing device programmed to enable rewarding the user, through the account, in accordance with the tracked data.

12. The system of claim 11, wherein the at least one marketing message includes an advertisement.

13. The system of claim 11, wherein the at least one marketing message includes a discount coupon.

14. The method of claim 11, wherein said rewarding step comprises applying a credit to the account.

15. The system of claim 11, wherein said marketing profile is in the form of a marketing score.

16. The system of claim 11, further comprising a computing device programmed to receive marketing attributes and determine a set of users that are of most value with respect to the marketing attributes based on the marketing profile.

17. The system of claim 11, further comprising a computing device programmed to notify a user that they have a marketing message.

18. The system of claim 11, further comprising a computing device programmed to screen a user for value by conducting said determining step in advance of other steps and determining whether to conduct the other steps based on the determining step.

19. The system of claim 11, wherein said computing device programmed to register is programmed to engaging the user in an on-line game and receive user information at least one of during or after play of the game.

20. The system of claim 11, wherein said computing device programmed to enable is programmed to present of at least one of the marketing messages through a local distribution channel and presentation of at least one of the marketing messages through a non-localized distribution channel.
